(19) United States
(12) Patent Application Publication
(10) Pub. No.: US 2013/0195262 A1
(43) Pub. Date: Aug. 1, 2013

(54) Techniques for Handling High Delay Fax Transmissions

(71) Applicants: M. David Hanes, Lewisville, NC (US); Gonzalo A. Salgueiro, Research Triangle Park, NC (US); Herbert M. Wildfeuer, Santa Barbara, CA (US); Michael Whitley, Holly Springs, NC (US)

(72) Inventors: M. David Hanes, Lewisville, NC (US); Gonzalo A. Salgueiro, Research Triangle Park, NC (US); Herbert M. Wildfeuer, Santa Barbara, CA (US); Michael Whitley, Holly Springs, NC (US)

(73) Assignee: CISCO TECHNOLOGY, INC., San Jose, CA (US)

(21) Appl. No.: 13/362,351

(22) Filed: Jan. 31, 2012

(51) Int. Cl. H04M 11/00

(52) U.S. Cl. 379/100.05

(57) ABSTRACT

A method, apparatus, and logic (encoded within a computer-readable tangible storage media) are provided for detecting, at an intermediate device, a presence of a delay for a fax communication between a source device and a destination device in a network. The delay for the fax communication is sufficient to produce a failure of a corresponding fax operation. The intermediate device includes a buffer to receive packets and is disposed in the network between the source and destination devices. A first time value of the buffer is adjusted at the intermediate device in response to detection of the delay to modify the delay to be within a range enabling the corresponding fax operation to be performed.

### TECHNICAL FIELD

The present disclosure relates to fax communications and, in particular, to detecting delays in fax communications and adjusting characteristics of the fax communications to enable the communications to be transmitted.

### BACKGROUND

Facsimile (“Fax”) communications enable messages to be sent between devices over large distances. Fax communications may be sent between devices using internet protocol (IP) packets within network environments, where devices connected to the same network (e.g., the Internet) can send and receive fax transmissions using fax over IP (FoIP) standards. FoIP communications, like other fax communications, may experience delays. For example, communication packets between a source network device and a destination network device may encounter queuing delays in various transit devices, thus causing a fax delay. In another example, both the source and the destination network devices may be transmitting negotiation messages to each other before reply messages are received from the other device. Since standard fax communications are half-duplex communications, at no time should messages from both network devices be transmitted at the same time. Thus, if messages from both network devices are transmitted together, the fax communication has a high delay problem. Fax communications may also experience jitter, which, for example, may be a variation in the time between packet transmissions.

The international telecommunication union (ITU) standard T.38 is the de facto standard for FoIP deployments. When T.38 codecs are loaded on network devices, playout buffers may be set with predetermined time values or lifetimes. Fax communications are generally more tolerant of packet delays than packet jitter, and thus, the playout buffer timeline is set to minimize the effect of packet jitters.

### BRIEF DESCRIPTION OF THE DRAWINGS

FIG. 1 is a diagrammatic illustration of an example network topology or environment having a gateway device that is configured to detect and avoid delays in facsimile (“fax”) communications between a source network device and a destination network device according to an embodiment.

FIG. 2 is block diagram of the gateway device configured to detect a presence of a delay for fax communications and to adjust time values of a buffer stored in the gateway device according to an embodiment.

FIGS. 3A-3C are diagrammatic illustrations of example network topologies in which a gateway device, according to an embodiment, may detect high levels of delays in fax communications between network devices.

FIGS. 4A and 4B are diagrammatic illustrations that show a buffer of the gateway device according to an embodiment.

FIG. 5 is a diagrammatic illustration of an example network topology where the gateway device adjusts the buffer upon detecting a high delay scenario according to an embodiment.

FIG. 6 is a flow chart showing a process for adjusting the buffer to reduce or minimize potential delays in fax communications according to an embodiment.

### DESCRIPTION OF EXAMPLE EMBODIMENTS

Overview

A method, apparatus, and logic (encoded within a computer-readable tangible storage media) are provided for detecting, at an intermediate device, a presence of a delay for a fax communication between a source device and a destination device in a network. The delay for the fax communication is sufficient to produce a failure of a corresponding fax operation. The intermediate device includes a buffer to receive packets and is disposed in the network between the source and destination devices. A first time value of the buffer is adjusted at the intermediate device in response to detection of the delay to modify the delay to be within a range enabling the corresponding fax operation to be performed.

### Example Embodiments

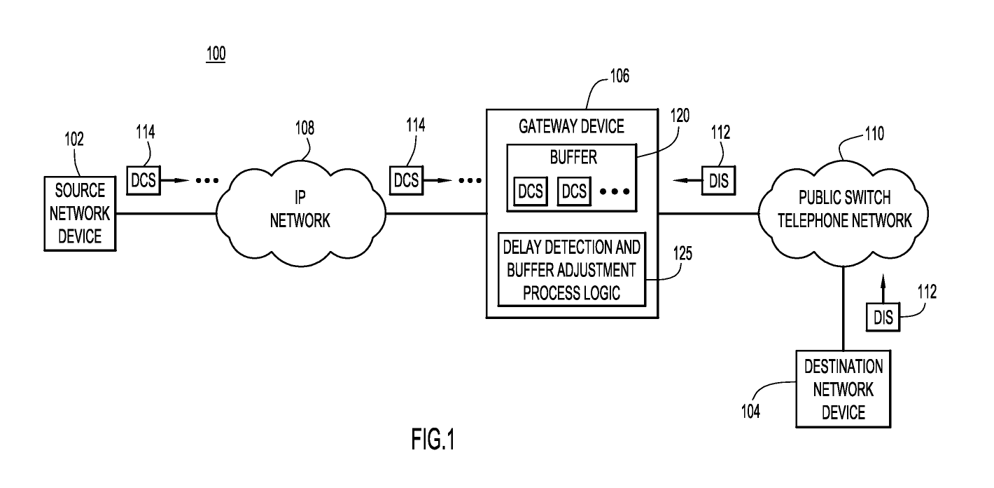

Embodiments described herein are directed to reducing delays pertaining to fax communications within a network environment. An example network topology having a gateway device configured to detect and avoid delays in facsimile (herein “fax”) communications between network devices according to an embodiment is illustrated in FIG. 1. Specifically, topology 100 includes a source network device 102, a destination network device 104 and a gateway device 106. The source network device 102 is configured to communicate with the gateway device 106 across an internet protocol (IP) network (e.g., the Internet) 108. The destination network device 104 is configured to communicate with the gateway device 106 across a public switch telephone network at 110. The source network device 102 is configured to send communications (e.g., fax communications) to the destination network device 104 via the gateway device 106 across the IP network 108 and the public switch telephone network 110.

The source network device 102 and destination network device 104 may be fax machines, computer devices, mobile devices, tablet devices, laptops, etc. enabled to connect with the IP network 108 and the public switch telephone network 110 and configured to send and receive fax communications. In one example, the source network device 102 and the destination network device 104 are configured to send fax over internet protocol (FoIP) communications, in accordance with the international telecommunication union (ITU) standard T.38, to each other via the gateway device 106. It should be appreciated that though FIG. 1 shows one source network device 102, one destination network device 104 and one gateway device 106, any number of source network devices, destination network devices and gateway devices may be used to enable fax communications between network devices. It should also be appreciated that the source network device 102 may be configured to operate as a destination network device and the destination network device 104 may be configured to operate as a source network device.

By way of example, in the course of initiating the fax communication, initialization messages are sent between the source network device 102 and the destination network device 104. For example, the destination network device 104 may initially send digital identification signal (DIS) messages 112 to the source network device 102 which, for example, contain information describing transmission and computing capabilities of the destination network device 104. In response, the source network device 102 may transmit digital command signal (DCS) messages 114 to the destination network device 104, which contain information describing the transmission and computing capabilities of the source network device 102.

Since the gateway device 106 is an intermediate device that resides between the source network device 102 and the destination network device 104, the gateway device 106 is configured to receive the DCS messages 114 from the source network device 102 and the DIS messages 112 from the destination network device 104. The DCS messages 114 and the DIS messages 112 may be exchanged as fax communications between the source network device 102 and the destination network device 104. It should be appreciated that the DCS messages 114 and the DIS messages 112 are described as examples and that any other types of initialization and response messages, or other fax communications, may be sent between the source network device 102 and the destination network device 104 via the gateway device 106.

The gateway device 106 has a buffer 120 that is configured to store packets of fax communications received from the source network device 102 or destination network device 104, as described according to the embodiments herein. FIG. 1 shows the buffer 120 storing packets of the DCS messages 114 sent from the source network device 102, though it should be appreciated that the buffer 120 may store packets for any type of fax communication message received from any network devices. The gateway device 106 also has a delay detection and buffer adjustment process logic 125 that, as described according to the embodiments herein, enables the gateway device 106 to detect delays in fax communications between the source network device 102 and the destination network device 104 and to adjust one or more properties of the buffer 120 accordingly to avoid or minimize these delays. In one example embodiment, the gateway device 106 is a multiplexer server (e.g., a time division multiplexer server) that is configured to receive packets of fax communications from the source network device 102 and to multiplex the packets to one or more destination network devices (e.g., the destination network device 104).

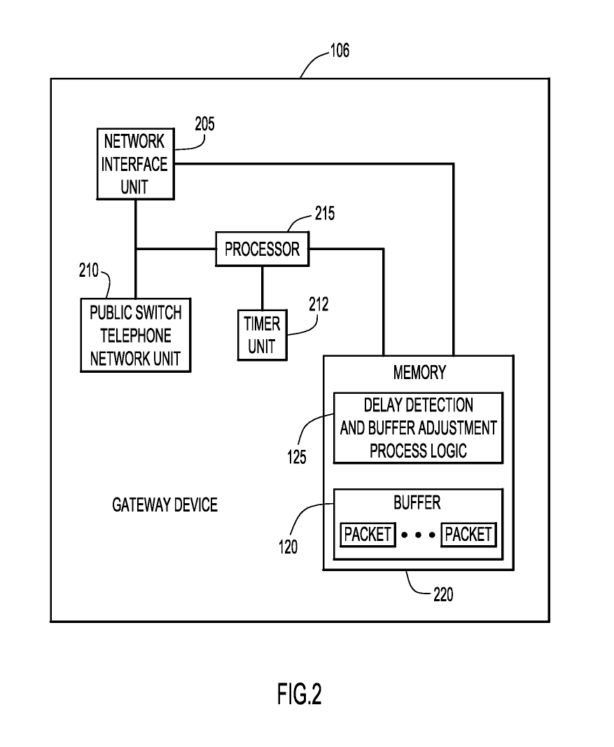

Reference is now made to FIG. 2, which shows a block diagram of the gateway device 106 according to an embodiment. The gateway device 106 comprises a network interface unit 205, a public switch telephone network unit 210, a timer unit 212, a processor 215 and a memory 220. The network interface unit 205 is coupled to the public switch telephone network unit 210, the processor 215 and the memory 220 and is configured to receive communications from one or more network devices (e.g., packets of fax communications from the source network device 102 and the destination network device 104).

The public switch telephone network unit 210 is coupled to the network interface unit 205 and the processor 215. The public switch telephone network unit 210 is configured to receive packets from the network interface unit 205 to perform packet switching operations for the received packets. The timer unit 212 is coupled to the processor 215 and is configured to determine time periods between the gateway device 106 receiving fax communication messages.

For example, as described in one embodiment herein, the timer unit 212 is configured to determine the time between receiving consecutive packets of DIS messages 112, DCS messages 114 or other fax communication messages.

The memory 220 is coupled to the network interface unit 205 and the processor 215. The memory 220 may be any form of random access memory (RAM) or other data storage block that stores data used for the techniques described herein. Memory 220 may be separate or part of processor 215. Instructions of the delay detection and buffer adjustment process logic 125 in the form of a software module may be stored in memory 220 for execution by processor 215 such that when the instructions are executed by processor 215, the instructions cause processor 215 to perform the operations described herein. The functions of processor 215 may be implemented by logic encoded in one or more tangible media or storage devices (e.g., memory devices such as compact discs, digital video discs, flash memory drives, etc. and embedded logic such as an application specific integrated circuit (ASIC), digital signal processor (DSP) instructions), wherein memory 220 stores data used for the computations or functions described herein. Thus, functions of the delay detection and buffer adjustment process logic may be implemented with fixed logic executed by a processor. The memory 220 also has the buffer 120 that is configured to store packets received from one or more network devices via the network interface unit 205, as described by the embodiments herein.

In general, the gateway device 106 is configured to receive fax communications (e.g., FoIP communications) from the source network device 102 across the IP network 108 and is configured to send or relay those communications to the destination network device 104 across the public switch telephone network 110. For example, as described above in connection with FIG. 1, the gateway device 106 may be an intermediate device that resides between two or more network devices. In this example, since the gateway device 106 resides between network devices, it is able to receive fax communications sent from one network device (e.g., the source network device 102) and is able to send these communications to another network device (e.g., the destination network device 104).

As described by embodiments herein, the gateway device 106 is also configured to detect delays in these communications between the source network device 102 and the destination network device 104. High levels of delays in the fax communications between the source network device 102 and the destination network device 104 may permanently interrupt the intended communications between these devices.

In a typical FoIP environment, the source network device 102, by virtue of being connected to the IP network 108, operates under the T.38 standard as a T.38 Group 3 device. The destination network device 104, by virtue of being connected to the public switch telephone network 110, operates under a T.30 standard for communication across the public switch telephone network 110. The gateway device 105 packages the T.30 communications from the destination network device 104 into T.38 communications for transmission to the source device 102 across the IP network 108. The source network device 102 and the destination network device 104 are configured with fax control message detection logic (e.g., to detect high channel signal encoding). When a fax communication is sent between network devices, the devices are able to detect the beginning and end of a communication by monitoring the high channel band energy associated with the communications. For example, ITU V.21 devices are configured to monitor “FLAG” messages in fax communications and are configured to determine an end-of-message communication by detecting a significant drop in V.21 high channel band energy.

The T.38 standard requires that these devices operate as half-duplex devices for fax communications, which means that at any point in time, communications from both the source network device 102 and the destination network device 104 should not be transmitted concurrently within the topology 100. In other words, if the source network device 102 is transmitting FoIP communications destined for the destination network device 104, the destination network device 104 should not also be transmitting communications destined for the source network device 102 at the same time and vice-versa. If the source network device 102 and the destination network device 104 are transmitting messages concurrently, the FoIP communications may be experiencing high transmission delays, which may ultimately cause the communications to fail or time out. For example, if each network device transmits messages (e.g., the DIS messages 112 and the DCS messages 114 shown in FIG. 1) concurrently before the other side has received the messages, the communications between the network devices will be delayed or dropped. In one example, the network devices will attempt to retransmit the messages for a predetermined number of times (e.g., three times), after which the transmission of the messages will time out, and the fax communication will fail.

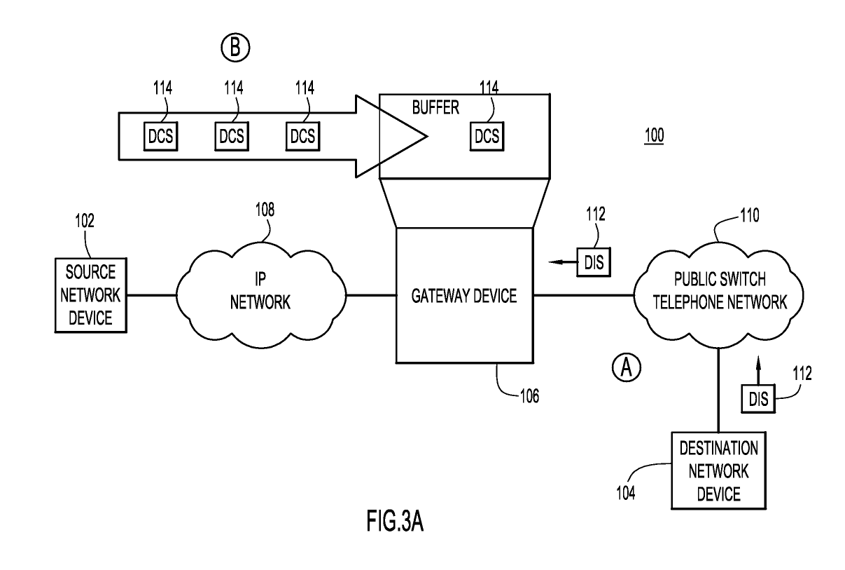

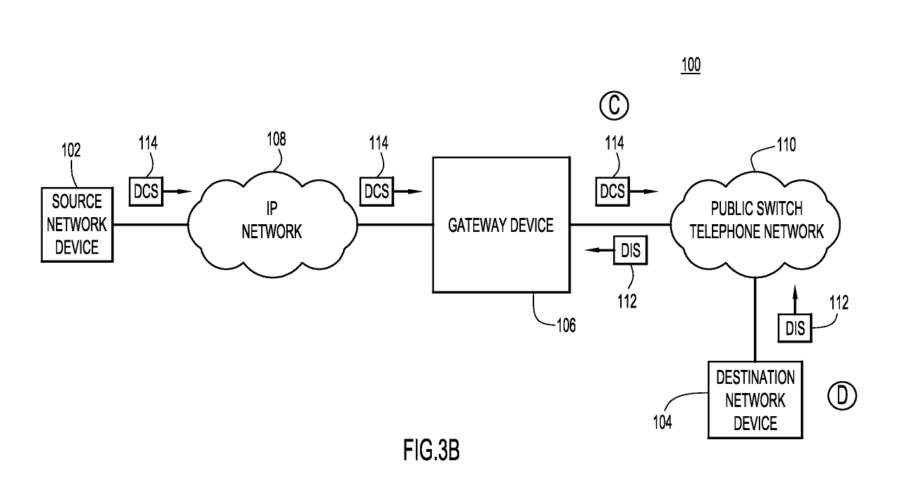

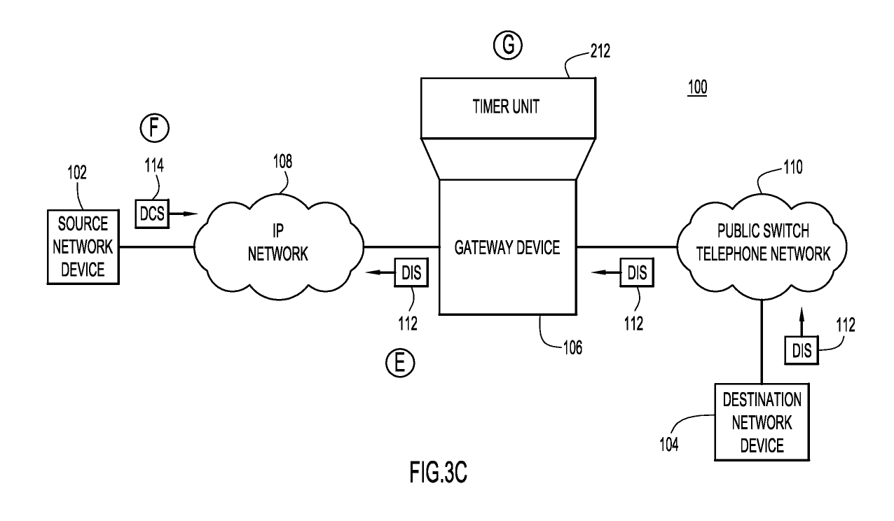

FIGS. 3A-3C show example network topologies in which the gateway device 106 may detect high levels of delays in fax communications between network devices (e.g., “high delay scenarios”). One example embodiment of a high delay scenario is shown in FIG. 3A, where topology 100 comprises the same components as described above in connection with FIG. 1. Reference point “A” in FIG. 3A describes the gateway device 106 receiving a packet of the DIS message 112 from the destination network device 104, and reference point “B” in FIG. 3A describes the gateway device 106 receiving packets of the DCS message 114. In this example, the DIS message 112 arrives at the gateway device 106 at the same time that the DCS message 114 is queued in the buffer 120 of the gateway device 106. Since the gateway device 106 receives packets of messages from the source network device 102 and the destination network device 104 concurrently, the half-duplex communication requirement described above is violated, and the gateway device 106 will detect a high delay scenario.

Another example embodiment of a network topology resulting in a high delay scenario is shown in FIG. 3B. Topology 100 in FIG. 3B has the same components described above in connection with FIG. 1. Reference point “C” describes a packet of the DCS message 114 being sent from the gateway device 106 to the destination network device 104 via the public switch telephone network 110. Reference point “D” indicates that the destination network device 104 does not receive the packet of the DCS message 114, but still sends a packet for the DIS message 112 to the gateway device 106. In this example, the DCS message 114 and the DIS message 112 are being sent concurrently by the source network device 102 and the destination network device 104, respectively. Likewise, the DCS message 114 and the DIS message 112 are received concurrently by the gateway device 106. In one example, the gateway device 106 receives the packet for the DIS message 112 while the packet for the DCS message 114 is still being transmitted. Thus, the gateway device 106 detects a high delay scenario since packets for both the DCS message 114 (originating from the source network device 102) and the DIS message 112 (originating from the destination network device 104) are being transmitted concurrently in the topology 100.

A further example embodiment of a network topology resulting in a high delay scenario is shown in FIG. 3C. Topology 100 in FIG. 3C has the same components described above in connection with FIG. 1. Reference point “E” describes a packet of the DIS message 112 being sent from the gateway device 106 to the source network device 102 via the IP network 108. Reference point “F” describes a packet of the DCS message 114 being sent from the source network device 102, in response to receiving the packet from the DIS message 112, to the gateway device 106. Reference point “G” indicates that the timer unit 212 determines that the packet of the DCS message 114 has not been received at the gateway device 106 within a predetermined time period after the transmission of DIS message 112, and as a result, the gateway device 106 preemptively identifies a high delay scenario.

In the example embodiments described in FIGS. 3A-3C, any fax communication messages may be used to determine high delay scenarios, and the DCS messages 114 and DIS messages 112 were used as examples for simplicity. When the gateway device 106 detects these high delay scenarios, the gateway device 106 is configured to adjust properties of the buffer 120 to modify the delay to be within an allowable range or time frame, thus enabling fax communications and operations between the source network device 102 and the destination network device 104, as described by the embodiments herein. In one embodiment, the gateway device 106 may adjust the buffer 120 to shrink a time value associated with the buffer. In another embodiment, the gateway device 106 may resolve the delay by marking packets associated with fax communications with higher priority quality of service (QoS) markings for more efficient and expedited routing of these packets between network devices to avoid or minimize the delays. For example, fax communications are often marked with default differentiated services code point (DSCP) values, which the gateway device 106 can change to a value with a high priority when a high delay scenario has been identified. Policy-based routing mechanisms can also be deployed to assist in cutting down the network delay. For example, efficient routes (e.g., high priority links reserved for high priority packets between network devices) may be available for routing in high delay scenarios.

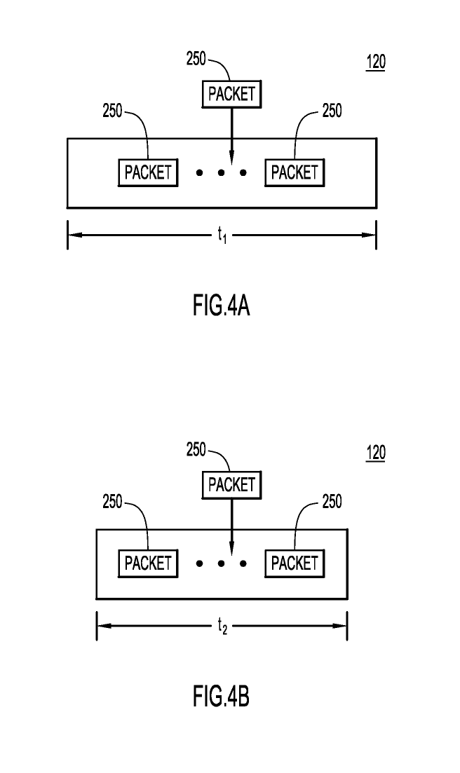

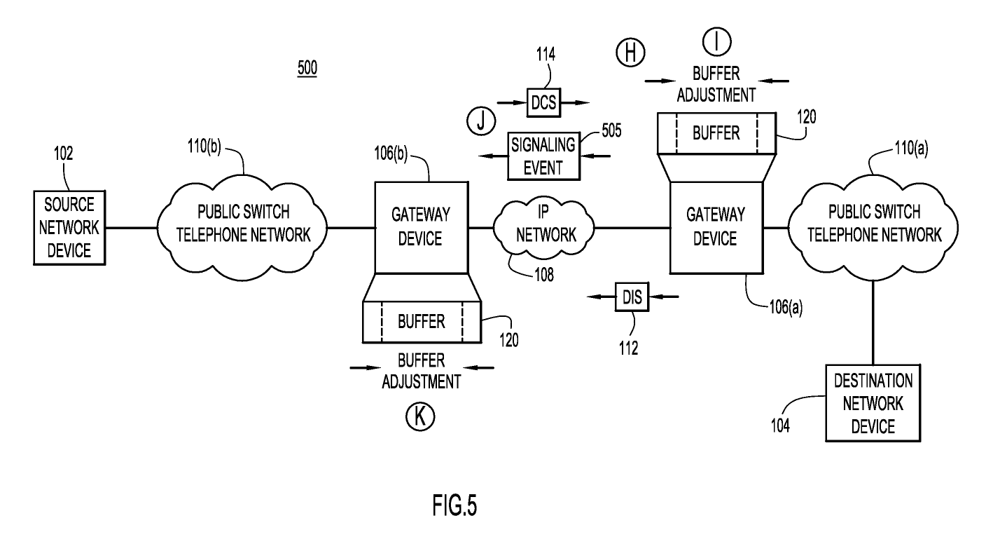

Reference is now made to FIGS. 4A and 4B, which show the buffer 120 according to one embodiment. In one example, the buffer 120 is an IP playout jitter buffer that is configured to store one or more packets 250 for fax communications received at the gateway device 106. The packets 250 may be received from the source network device 102 for ultimate transmission to the destination network device 104 or may be received from the destination network device 104 for ultimate transmission to the source network device 102. In general, the buffer 120 is configured to store the packets 250 for a predetermined time period to increase the jitter tolerance of fax communications between network devices. In other words, the gateway device 106 is configured to receive the packets 250, and these packets 250 are held in the buffer 120 for a predetermined period of time in order to increase the jitter tolerance for the fax communications associated with the packets 250. The packets 250 may be packets of the DIS messages 112, DCS messages 114 or other fax communication messages between the source network device 102 and the destination network device 104.

The ITU T.38 standard is the de facto standard for FoIP deployments. When T.38 codecs are loaded on network devices such as the source network device 102 and the destination network device 104, playout buffers may be set with predetermined time values or lifetimes. Fax communications are generally more tolerant of packet delays than packet jitter, and thus, the playout buffer timeline is set to minimize the effect of packet jitters. In one example, a 300 millisecond time value may be set for the playout buffer for FoIP communications operating under the ITU T.38 standard. In this example, the relatively deep playout buffer of 300 milliseconds increases the packet jitter tolerance of fax communications while not affecting the delay tolerance significantly. The gateway device 106 is configured to adjust this time value when it detects high delay scenarios for fax communications (e.g., FoIP communications) between the source network device 102 and the destination network device 104.

For example, FIG. 4A shows the buffer 120 having a first time value t₁, during which the packets 250 are received from the source network device 102 and stored and held in the buffer 120. Upon detecting a high delay scenario, the gateway device 106 is configured to adjust the first time value t₁ shown in FIG. 4A to a new time value t₂, as shown in FIG. 4B. The buffer 120 in FIG. 4B still receives the packets 250 from the source network device 102; however, the packets 250 remain in the buffer for a smaller time period when compared to the buffer 120 in FIG. 4A, thereby reducing delay.

By adjusting the time value of the buffer 120, the gateway device 106 prevents high delay scenarios. In general, the buffer 120 is configured to store packets that are sent from devices connected to the IP network 108 (e.g., the source network device 102) to devices connected to the public switch telephone network 110 (e.g., the destination network device 104). Packets that are sent from devices connected to the public switch telephone network 110 typically are not stored in the buffer 120 of the gateway device. In certain network topologies, there may be gateway devices located on each end of the IP network 108, and each of these gateway devices may store the buffer 120 to store packets received over the IP network 108.

In one example, when the buffer 120 has a first time value (t₁) of 300 milliseconds, packets that are sent from the source network device 102 across the IP network 108 to the destination network device 104 across the public switch telephone network 110 are delayed by 300 milliseconds since these packets are stored in the buffer 120 having the first time value of 300 milliseconds. When response packets are sent from the destination network device 104 to the source network device 102, the response packets are not stored in the buffer 120, since these packets are not received across the IP network 108. Thus, in this example, the round trip delay for communications between the source network device 102 and the destination network device 104 is 300 milliseconds. In the example where there is one gateway device located on each end of the IP network 108, packets that are sent from the source network device 102 across the IP network 108 have to pass through two gateway devices, each having the buffer 120 at the first time value. As stated above, the response packets from the destination network device 104 are not stored in the buffer 120 of the gateway devices, and thus, these packets are delayed (e.g., have a round trip delay value) by 600 milliseconds, or twice the first time value 300 milliseconds. It should be appreciated that the round trip delay value can be determined for network topologies having any number of gateway devices.

FoIP communications typically handle delays of two to three seconds, and in certain complex topologies, these delay budgets can be exceeded. Communications that exceed the delay budgets are typically dropped from transmission. If the gateway device 106 adjusts the first time value of the buffer 120 to obtain a new time value (t₂) of, for example, 100 milliseconds, the round trip delay for a fax communication will be 200 milliseconds. In this example, the new time value of the buffer 120 may ensure that the round trip time for packet transmissions is below the delay budget. Thus, the communications would not be interrupted. In another example, the first time value of the buffer 120 may be compared to a delay budget for a one way communication between network devices, and the first time value may be adjusted to a new time value based on the one way trip time for packet transmission compared to this delay budget for one way communications.

The gateway device 106 typically chooses an aggressive value (e.g., a low time value for the buffer 120) for the new time value (t₂) since FoIP network devices typically time out after multiple retransmissions. For example, at least one retransmission usually has to occur to detect the high delay scenario initially, and as a result, there may not be enough time to gradually or incrementally shrink the buffer 120 to determine what time value is both optimal for maximizing the jitter tolerance associated with the buffer 120 time value and for minimizing the delay between the network devices such that the fax communications do not fail. Also, there will be some delay over, for example, the IP network 108 so that the network devices (e.g., the gateway device 106) can signal other gateway devices in the network to lower their corresponding buffers in a high delay scenario. Thus, the gateway device 106 may select an aggressive time value (e.g., 75 milliseconds to 100 milliseconds) for which to adjust the buffer 120 once the high delay scenario is detected. In many cases, this time value is adequate to ensure transmission of the fax communication while still providing an additional buffer for other fax communications.

Reference is now made to FIG. 5, which shows an example embodiment of a network topology where the gateway device 106 adjusts the buffer 120 upon detecting a high delay scenario. Topology 500 in FIG. 5 has components similar to those in FIG. 1 above. FIG. 5 shows a first gateway device 106(a) configured to communicate with the destination network device 104 across a first public switch telephone network 110(a). FIG. 5 also shows a second gateway device 106(b) configured to communicate with the source network device 102 across a second public switch telephone network 110(b). The first gateway device 106(a) and the second gateway device 106(b) are configured to communicate with each other across the IP network 108. The gateway devices 106(a) and 106(b) are similar to the gateway device 106 described above. Additionally, the IP network 108 and the public switch telephone networks 110(a) and 110(b) are similar to the IP network 108 and public switch telephone network 110 described above. According to one embodiment, the first gateway device 106(a) may be configured as a terminating voice gateway device and the second gateway device 106(b) may be configured as an originating voice gateway device.

In FIG. 5, reference point “H” shows the first gateway device 106(a) receiving a packet of the DCS message 114 concurrently with a packet for the DIS message 112. Thus, as described above, the first gateway device 106(a) detects a high delay scenario, and accordingly, as shown at reference point “I,” adjusts the buffer 120 associated with the first gateway device 106(a). For example, the first gateway device 106(a) may adjust the time value of the buffer 120 associated with the first gateway device 106(a) from 300 milliseconds to 100 milliseconds.

After adjusting the buffer 120, the first gateway device 106(a) sends an indication (e.g., a signaling event message 505) as shown at reference point “J,” to the second gateway device 106(b) to indicate the presence of a high delay scenario. The signaling event message 505 informs the second gateway device 106(b) that a high delay scenario is present and also, according to one embodiment, instructs the second gateway device 106(b) to adjust the buffer 120 associated with the second gateway device 106(b). In one example, the signaling event message may be an IP version 4 (IPv4) protocol options field or IP version 6 (IPv6) protocol flow label. In another example, the signaling event message 505 may be an ITU T.30 non-standard facilities (NSF) command message that may be sent along with a DIS message from the destination device 104 to inform all gateway devices between the destination device 104 and the source device 102 of the high delay scenario. In another example, the signaling event may be a named telephone event (NTE) message defined in the RFC 2833 protocol.

Reference point “K” shows the second gateway device 106(b) adjusting the buffer 120 associated with the second gateway device 106(b). For example, the second gateway device 106(b) may adjust the time value of the buffer 120 associated with the second gateway device 106(b) in a similar manner as the buffer 120 associated with the first gateway device 106(a). In another example, the second gateway device 106(b) may adjust the time value of the buffer 120 associated with the second gateway device 106(b) to a different time value than the buffer 120 associated with the first gateway device 106(a). Thus, by sending the signaling event message, the first gateway device 106(a) can inform other gateway devices (e.g., the second gateway device 106(b)) or other network devices in general in the topology 100 of the presence of a high delay scenario to enable the other gateway devices or the other network devices to adjust their buffers accordingly or take other appropriate action.

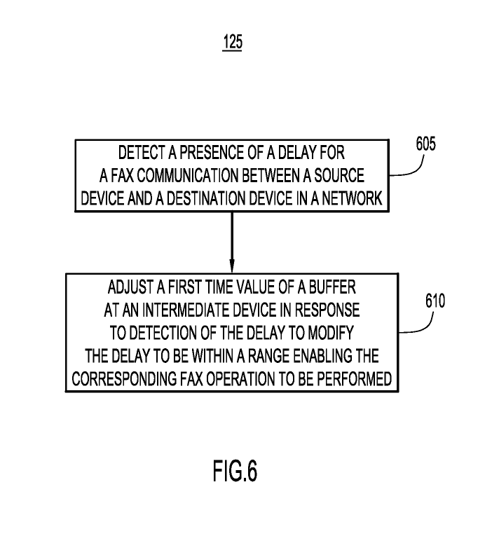

Reference is now made to FIG. 6, which shows a flow chart for a process for the delay detection and buffer adjustment process logic 125 to adjust the buffer 120 in order to minimize potential delays in fax communications, according to one embodiment. The operations shown in FIG. 6 may be performed, for example, by the processor 215 of the gateway device 106. At operation 605, the delay detection and buffer adjustment process logic 125 detects a presence of a delay for a fax communication between a source device (e.g., the source network device 102) and a destination device (e.g., the destination network device 104) in a network. At 610, the logic adjusts a first time value of a buffer (e.g., the buffer 120) at an intermediate device (e.g., the gateway device 106) in response to detection of the delay to modify the delay to be within a range enabling the corresponding fax operation to be performed. For example, as stated above, the intermediate device can lower or shrink the first time value to obtain a second time value for the buffer. As stated above, changing the QoS priority and invoking policy based routing are additional measures that can be used for reducing high delay scenarios.

The topology or environment of the present embodiments may include any number of computer or other processing systems (e.g., client or end-user systems, server systems, etc.) arranged in any desired fashion, where these embodiments may be applied to any desired type of computing environment (e.g., cloud computing, client-server, network computing, etc.). The computer or other processing systems (e.g., client systems, server systems, etc.) employed by these embodiments may be implemented by any number of any personal or other type of computer or processing system (e.g., IBM-compatible, APPLE, laptop, tablets, etc.), and may include any commercially available operating system and any commercially available or custom software (e.g., browser software, communications software, server software, delay detection and buffer adjustment logic modules, etc.). These systems may include any types of monitors and input devices (e.g., keyboard, mouse, voice recognition, touch screen, etc.) to enter and/or view information.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present embodiments may be distributed in any manner among the source network device 102, the destination network device 105, the gateway device 106, the IP network 108 or the public switch telephone network 110. The software and/or algorithms described above and illustrated in the flow charts and/or diagrams may be modified in any manner that accomplishes the functions described herein. In addition, the functions in the flow charts and/or diagrams or description may be performed in any order that accomplishes a desired operation.

Further, the memories of the computer systems or devices of present embodiments may comprise read only memory (ROM), random access memory (RAM), magnetic disk storage media devices, optical storage media devices, flash memory devices, electrical, optical, or other physical/tangible memory storage devices. Thus, in general, the memory may comprise one or more computer readable tangible (non-transitory) storage media (e.g., a memory device) encoded with software or logic (e.g., delay detection and buffer adjustment process logic 125) comprising computer executable instructions and, when executed (by the corresponding processor of the computer system or device), the software is operable to perform the operations described herein.

The network topology may be implemented by any number and any type of communications network (e.g., LAN, WAN, Internet, Intranet, VPN, etc.). The computer or other processing systems of these embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

These embodiments may employ any number of any conventional or other databases, data stores or storage structures (e.g., files, databases, data structures, data or other repositories, etc.) to store information. A database system may be included within or coupled to the server and/or client systems. The database system and/or storage structure may be remote from or local to the computer or other processing systems, and may store any desired data.

It will be understood that the terms “comprises”, “comprising”, “includes”, “including”, “has”, “have”, “having”, “with” and the like, when used in this specification and the claims, specify the presence of stated features, but do not preclude the presence or addition of one or more other features.

From the foregoing description, it will be appreciated that the techniques disclosed herein make available novel embodiments for obtaining information pertaining to fax communications between network devices and adjustment of characteristics of fax communications to ensure that the communications be transmitted.

Having described example embodiments of a new and improved technique for detecting high delays in fax communications between network devices and adjusting characteristics of fax communications to prevent or minimize these delays, it is believed that other modifications, variations and changes will be suggested to those skilled in the art in view of the teachings set forth herein. It is therefore to be understood that all such variations, modifications and changes are believed to fall within the scope as defined by the appended claims.

It should be appreciated that the techniques described above in connection with all embodiments may be performed by one or more computer readable storage media that is encoded with software comprising computer executable instructions to perform the methods and steps described herein.

In sum, a method is provided comprising: detecting at a first intermediate device a presence of a delay for a fax communication between a source device and a destination device in a network, wherein the delay for the fax communication is sufficient to produce a failure of a corresponding fax operation, and wherein the first intermediate device includes a buffer to receive packets and is disposed in the network between the source and destination devices; and adjusting a first buffer time value of the buffer at the first intermediate device to a new first buffer time value in response to detection of the delay to modify the delay to be within a range enabling the corresponding fax operation to be performed.

Additionally, one or more computer readable storage media encoded with software is provided comprising computer executable instructions and when the software is executed operable to: detect at a first intermediate device a presence of a delay for a fax communication between a source device and a destination device in a network, wherein the delay for the fax communication is sufficient to produce a failure of a corresponding fax operation, and wherein the first intermediate device includes a buffer to receive packets and is disposed in the network between the source and destination devices; and adjust a first buffer time value of the buffer at the first intermediate device to a new first buffer time value in response to detection of the delay to modify the delay to be within a range enabling the corresponding fax operation to be performed.

Furthermore, an apparatus is provided comprising: a network interface unit; a memory coupled to the network interface unit; and a processor coupled to the network interface unit and the memory and configured to: detect a presence of a delay for a fax communication received at the network interface unit between a source device and a destination device in a network, wherein the delay for the fax communication is sufficient to produce a failure of a corresponding fax operation; and adjust a first buffer time value of a buffer stored in the memory and configured to receive packets to a new first buffer time value in response to detection of the delay to modify the delay to be within a range enabling the corresponding fax operation to be performed.

What is claimed is:

1. A method comprising:
detecting at a first intermediate device a presence of a delay for a fax communication between a source device and a destination device in a network, wherein the delay for the fax communication is sufficient to produce a failure of a corresponding fax operation, and wherein the first intermediate device includes a buffer to receive packets and is disposed in the network between the source and destination devices; and
adjusting a first buffer time value of the buffer at the first intermediate device to a new first buffer time value in response to detection of the delay to modify the delay to be within a range enabling the corresponding fax operation to be performed.

2. The method of claim 1, further comprising sending an indication to a second intermediate device in the network when the presence of the delay is detected, wherein the indication is a signaling event message that informs the second intermediate device of the delay.

3. The method of claim 2, wherein sending comprises sending the indication with instructions for the second intermediate device to adjust a second buffer time value of a buffer at the second intermediate device to a new second buffer time value.

4. The method of claim 3, wherein sending the indication with the instructions to adjust the second buffer comprises instructions instructing the second intermediate device to adjust the second buffer time value to the new second buffer time value that is a same time value as the new first buffer time value.

5. The method of claim 1, wherein adjusting comprises decreasing the first buffer time value such that the new first buffer time value is less than the first buffer time value.

6. The method of claim 1, further comprising sending an indication to notify multiple devices in the network of the presence of the delay.

7. The method of claim 6, wherein sending the indication comprises sending one of an internet protocol (IP) version 4 (IPv4) protocol message, IP version 6 (IPv6) message, a non-standard facilities (NSF) command message and a named telephone event (NTE) message.

8. The method of claim 1, wherein detecting comprises detecting the presence of the delay when the intermediate device receives messages from the source device and the destination device concurrently.

9. The method of claim 1, wherein detecting comprises detecting the presence of the delay when the intermediate device does not receive a response message from the destination device within a predetermined time period from receiving an initial message from the source device.

10. The method of claim 1, further comprising marking packets associated with the fax communication as high priority packets when the delay is detected.

11. The method of claim 10, wherein marking comprises marking the packets such that the packets are transmitted from the source device to the destination device via high priority links reserved for high priority packets.

12. One or more computer readable storage media encoded with software comprising computer executable instructions and when the software is executed operable to:
detect at a first intermediate device a presence of a delay for a fax communication between a source device and a destination device in a network, wherein the delay for the fax communication is sufficient to produce a failure of a corresponding fax operation, and wherein the first intermediate device includes a buffer to receive packets and is disposed in the network between the source and destination devices; and
adjust a first buffer time value of the buffer at the first intermediate device to a new first buffer time value in response to detection of the delay to modify the delay to be within a range enabling the corresponding fax operation to be performed.

13. The one or more computer readable storage media of claim 12, further comprising instructions operable to send an indication to a second intermediate device in the network when the presence of the delay is detected, wherein the indication is a signaling event message that informs the second intermediate device of the delay.

14. The one or more computer readable storage media of claim 13, wherein the instructions operable to send comprise instructions operable to send the indication with instructions for the second intermediate device to adjust a second buffer time value of a buffer at the second intermediate device to a new second buffer time value.

15. The one or more computer readable storage media of claim 14, wherein the instructions operable to send the indication with the instructions to adjust the second buffer comprise instructions operable to instruct the second intermediate device to adjust the second buffer time value to the new second buffer time value that is a same time value as the new first buffer time value.

16. The one or more computer readable storage media of claim 12, wherein the instructions operable to adjust comprise instructions operable to decrease the first buffer time value such that the new first buffer time value is less than the first buffer time value.

17. The one or more computer readable storage media of claim 12, further comprising instructions operable to send an indication to notify multiple devices in the network of the presence of the delay.

18. The one or more computer readable storage media of claim 17, wherein the instructions operable to send the indication comprise instructions operable to send one of an internet protocol (IP) version 4 (IPv4) protocol message, IP version 6 (IPv6) message, a non-standard facilities (NSF) command message and a named telephone event (NTE) message.

19. The one or more computer readable storage media of claim 12, wherein the instructions operable to detect comprise instructions operable to detect the presence of the delay when the intermediate device receives messages from the source device and the destination device concurrently.

20. The one or more computer readable storage media of claim 12, wherein the instructions operable to detect comprise instructions operable to detect the presence of the delay when the intermediate device does not receive a response message from the destination device within a predetermine time period from receiving an initial message from the source device.

21. The one or more computer readable storage media of claim 12, further comprising instructions operable to mark packets associated with the fax communication as high priority packets when the delay is detected.

22. The one or more computer readable storage media of claim 21, wherein the instructions operable to mark comprise instructions operable to mark the packets such that the packets are transmitted from the source device to the destination device via high priority links reserved for high priority packets.

23. An apparatus comprising:
a network interface unit;
a memory coupled to the network interface unit; and
a processor coupled to the network interface unit and the memory and configured to:
detect a presence of a delay for a fax communication received at the network interface unit between a source device and a destination device in a network, wherein the delay for the fax communication is sufficient to produce a failure of a corresponding fax operation; and
adjust a first buffer time value of a buffer stored in the memory and configured to receive packets to a new first buffer time value in response to detection of the delay to modify the delay to be within a range enabling the corresponding fax operation to be performed.

24. The apparatus of claim 23, wherein the processor is further configured to send an indication to an intermediate device in the network when the presence of the delay is detected, wherein the indication is a signaling event message that informs the intermediate device of the delay.

25. The apparatus of claim 24, wherein the processor is further configured to send the indication with instructions for the intermediate device to adjust a second buffer time value of a buffer at the intermediate device to a new second buffer time value.

26. The apparatus of claim 23, wherein the processor is further configured to detect the presence of the delay when the network interface unit receives messages from the source device and the destination device concurrently.

27. The apparatus of claim 23, wherein the processor is further configured to detect the presence of the delay when the network interface unit does not receive a response message from the destination device within a predetermined time period from receiving an initial message from the source device.
